(19) United States
(12) Patent Application Publication
(10) Pub. No.: US 2023/0114019 A1
(43) Pub. Date: Apr. 13, 2023

(54) METHOD AND APPARATUS FOR THE SEMI-AUTONOMOUS MANAGEMENT, ANALYSIS AND DISTRIBUTION OF INTELLECTUAL PROPERTY ASSETS BETWEEN VARIOUS ENTITIES

(71) Applicant: NICOLE ANN SHANAHAN, PALO ALTO, CA (US)

(72) Inventor: NICOLE ANN SHANAHAN, PALO ALTO, CA (US)

(21) Appl. No.: 17/948,091

(22) Filed: Sep. 19, 2022

Related U.S. Application Data
(63) Continuation of application No. 16/939,841, filed on Jul. 27, 2020, now abandoned.
Application No. 16/939,841 is a continuation of application No. 15/482,517, filed on Apr. 7, 2017, now abandoned.

(51) Int. Cl. G06Q 50/18; G06Q 10/10; G06N 20/00

(52) U.S. Cl. CPC G06Q 50/184; G06Q 10/103; G06N 20/00

(57) ABSTRACT

The present disclosure relates generally to a platform for allowing users to use machine assistance in the management, analysis, and transaction of intellectual property assets. The system supports the automation of intellectual asset docketing and related information management tasks. The system also supports the analysis of intellectual assets using machine learning techniques. The system is provided via the Internet and may operate as a software as a service. In the context of asset management, a software program is provided to continuously manage and monitor government intellectual property office data. In the context of asset analysis, a virtual data room (or deal room) is provided to strategically organize assets. In the context of intellectual asset analysis, a machine learning program is provided to interpret intellectual assets. The machine learning program provides insights into the innovation landscape, relevant organizations, products, research and the like. The machine learning program performs tasks analogous to a professional intellectual asset analysis.

### PRIORITY CLAIMS

This application is a continuation of U.S. patent application Ser. No. 16/939,841, filed on Jul. 27, 2020, which is a continuation of U.S. patent application Ser. No. 15/482,517 filed on Apr. 7, 2017, the contents of which are incorporated herein by reference.

### TECHNICAL FIELD

The present disclosure relates generally to a platform for allowing users to use machine assistance in the management, analysis, and transaction of intellectual property assets. The system supports the automation of intellectual asset docketing and related information management tasks. The system also supports the analysis of intellectual assets using machine learning techniques. The system is provided via the Internet and may operate as a software as a service. In the context of asset management, a software program is provided to continuously manage and monitor government intellectual property office data. In the context of asset analysis, a virtual data room (or deal room) is provided to strategically organize assets. In the context of intellectual asset analysis, a machine learning program is provided to interpret intellectual assets. The machine learning program provides insights into the innovation landscape, relevant organizations, products, research and the like. The machine learning program performs tasks analogous to a professional intellectual asset analysis. The system is designed in a way that information can be made both public and private and used to stimulate collaboration among parties. Such that an enterprise, multi-user configuration is available to organize and enable groups of intellectual property stakeholders.

### BACKGROUND OF THE INVENTION

Intellectual Property Assets have great value to entities in the freedom to operate in a technical space and there are an ever-increasing number of individuals, entities, and companies filing patent applications worldwide limiting this freedom to operate. However, the ability these parties to generate value from these intellectual property assets remains limited even though such assets can pose significant impediments to operating entities.

In the past proprietary market places or exchanges have attempted to garner attention and create an online market place for the licensing and selling of such IP assets. These types of exchanges have had limited success because of the lack of user controls, the limited number of assets, the limited number of users, and the obligations imposed by the various exchanges themselves when submitting the IP assets to the exchanges.

IP assets are unique and therefore exchanges fail to understand the market needs involved in the complex business of licensing, selling and distributing information about these assets. In addition, exchanges fail to provide user controls in this distribution as well as contacts and feedback when such assets are distributed to third parties.

The present invention overcomes the deficiencies of IP exchanges by providing a dynamic user platform for the distribution, management, and valuation pf IP assets along with user controls and the ability to conveniently distribute additional information along with the IP assets needed to consummate an IP transaction.

### SUMMARY OF THE INVENTION

The present invention provides for an interface of a software platform for managing the creation, monitoring, sharing, distributing and aggregation of information relating to intellectual property assets for enabling the convenient distribution of these assets to and from multiple entities and for the collaborative interaction between the various entities.

Accordingly, one embodiment of the present invention is an interface for recording, accessing and storing intellectual asset information for continuous monitoring against a plurality of APIs containing up-to-date government intellectual property records. A back-end statutory rules engine reads the API and pairs relevant documents with relevant actions required of the document. Effectively, the rules engine is programmed using computational logic to detect and implement a series of actions to be taken. In one example, the API feed includes several nodes that pair with trigger actions on the rules database. Once paired, the trigger actions perform one or a plurality of scheduling tasks. All scheduling tasks are ordered and filtered chronologically, and easily manipulated to filter and sort through time.

Accordingly, another embodiment of the present invention contains a virtual data room for sharing additional market information. The virtual data room allows users to complete unique transactional opportunities. The virtual data allows users to link to a plurality of intellectual property assets. The linking allows those viewing the virtual data room to access intellectual property records that are maintained by the computational logic program. The virtual data room also allows for additional data inputs from other data services such as patent search and analytics, valuation metrics, competitive related corporations, and relevant products relating to the intellectual property.

According to yet another embodiment of the present invention is the implementation of a machine learning system that powers a variety of analytics, analogous to those provided by an intellectual property analyst. The machine learning system utilizes a convolution neural network to return accurate patent search results. The patent search results can be used to determine the entire competitive landscape of intellectual property assets. The results can be displayed by inputting text. The text is paired and weighted against all patent assets existing in the government patent corpus.

This summary contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 [100] illustrates a diagram a flow diagram of the overall system working cohesively to manage, analyze, and transact intellectual property assets;

FIG. 1 [101] represents the portfolio management segment of the system that includes docketing, document management, chronological due dates, records management, and invention disclosures (which includes a functionality to run the machine learning engine);

FIG. 1 [102] represents the virtual deal room segment of the system that includes a virtual data room (which includes a functionality to run the machine learning engine), an aggregated view of IP assets, share functionality, document and contract attachments and the like;

FIG. 1 [103] represents the user interface ability to toggle between portfolio management [101] and the virtual deal room segment [102];

FIG. 1 [104] represents the computational logic that is run continuously on all imported intellectual property assets that applies new data and updates and they are detected via a plurality of APIs;

FIG. 2 [200] is a flow diagram of the complete system representing how the back end and front-end interact to provide an end-to-end platform for intellectual property asset management, analysis, and transaction;

FIG. 2 [201] represents the portfolio management front-end user interface where users are able to perform a number of user actions, and experience a number of user views;

FIG. 2 [202] is the transmission of user provided intellectual asset serial numbers to user databases;

FIG. 2 [203] represents the user databases where user data is stored and represented via the front-end [101];

FIG. 2 [204] represents the API that registers user serial numbers against a database containing all government intellectual asset data;

FIG. 2 [205] represents bulk databases of a plurality of government intellectual asset data sets;

FIG. 2 [206] represents the API that sends packets of data for registered user back to the user databases [203];

FIG. 2 [207] is the computational logic rules engine that processes registered user data against a set of rules that determine the status of relevant actions related to the registered user data;

FIG. 2 [208] is the process of submitted the registered user data and the related rules to the user databases;

FIG. 2 [209] represented the process of displaying the completed user records to the user via the front-end [201];

FIG. 2 [210] is the Invention Disclosure front-end containing an interface for a number of user actions and user views;

FIG. 2 [211] is the process by which the user database stores and provides data for the user interface;

FIG. 2 [212] is the virtual IP deal room front-end containing an interface for a number of user actions and user views;

FIG. 2 [213] is the process by which the user database stores and provides data for the virtual IP deal room user interface;

FIG. 2 [214] is the machine learning analytics engine containing a plurality of databases, crawl bots, and functions;

FIG. 2 [215] is the API JSON file that sends invention disclosure contents to the machine learning analytics engine;

FIG. 2 [216] is the analytics databases storing a plurality of collected data sets related to the intellectual assets analytics engine [214];

FIG. 2 [217] a second set of bulk databases containing government intellectual property data;

FIG. 2 [217] a machine learning model that is trained on the bulk databases [217];

FIG. 2 [219] the program designed to continuously train the machine learning model on new entering the bulk databases [217];

FIG. 2 [220] the machine learning model provides answers and search results based on inputs requested by the user via the user front-ends [210] and [212], and the results are stored in the analytics database [216];

FIG. 2 [221] is an articles crawl bot that crawls and extracts written content from a wide plurality of online sources;

FIG. 2 [222] is the process by which the articles crawl bot [221] provides content related to user inputs from [210] and [212] to the analytics databases;

FIG. 2 [223] is an inventor crawl bot that crawls inventor information from a plurality of online sources;

FIG. 2 [224] is the process by which the inventor crawl bot [223] provides content related to user inputs from [210] and [212] to the analytics databases;

FIG. 2 [225] is a product crawl both that crawls product information from a plurality of online sources;

FIG. 2 [226] is the process by which the product crawl bot [225] provides content related to user inputs from [210] and [212] to the analytics databases;

FIG. 2 [227] is an organization crawl both that crawls organization information from a plurality of online sources;

FIG. 2 [228] is the process by which the organization crawl bot [227] provides content related to user inputs from [210] and [212] to the analytics databases;

FIG. 2 [229] is a sentiment model and crawl bot that crawls opinion information from a plurality of online sources;

FIG. 2 [230] is the process by which the sentiment model and crawl bot [229] provides sentiment analysis related to user inputs from [210] and [212];

FIG. 2 [231] is the API JSON content that is provided by the user via the virtual IP Deal Room Front-End [212], to the Machine Learning Analytics Engine [214] for processing;

FIG. 2 [232] is the API JSON content that is provided to front-end [212] after the machine learning analytics engine [214] has completed processing;

FIG. 2 [233] is the user front-end analytics dashboard where user can dynamically explore a plurality of data provided by the machine learning engine [214];

FIG. 2 [234] is the API JSON content that is provided to the analytics dashboard front-end [233] after processing by the machine learning analytics engine [214];

FIG. 3 is the user interface for the administrator dashboard;

FIG. 4 is the user interface for a newly created profile, allowing the user to import new intellectual asset serial numbers;

FIG. 5 is the user interface of a populated profile account, and the All Applications tab;

FIG. 6 is the user interface of the New Actions tab of the Pending Applications section of the application;

FIG. 7 is the user interface of the Pending Actions tab of the of the Pending Applications section of the application;

FIG. 8 is the user interface for selecting and automating any extensions related to a New or Pending Action;

FIG. 9 is the reports generation user interface;

FIG. 10 is the invention disclosure user interface;

FIG. 11 is the All DealRooms interface of the virtual deal room;

FIG. 12 is the edit view of a selected virtual deal room;

FIG. 13 is the edit view of a selected virtual deal room, with the Patent Records selection tab in view;

FIG. 14 is the edit view of a selected virtual deal room, with the Supporting Files selection tab in view;

FIG. 15 is the viewer interface of a completed virtual deal room, available via the editor and via link as a view-only or limited-view document;

FIG. 16 is an encrypted URL provided via the share function of a particular virtual deal room;

FIG. 17 is the user interface of the analytics dashboard using the data produced by the Machine Learning Analytics Engine.

### DETAILED DESCRIPTION OF THE PREFERRED EMBODIMENT

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or client devices. When a component appears in several embodiments, the use of the same reference numeral signifies that the component is the same component as illustrated in the original embodiment.

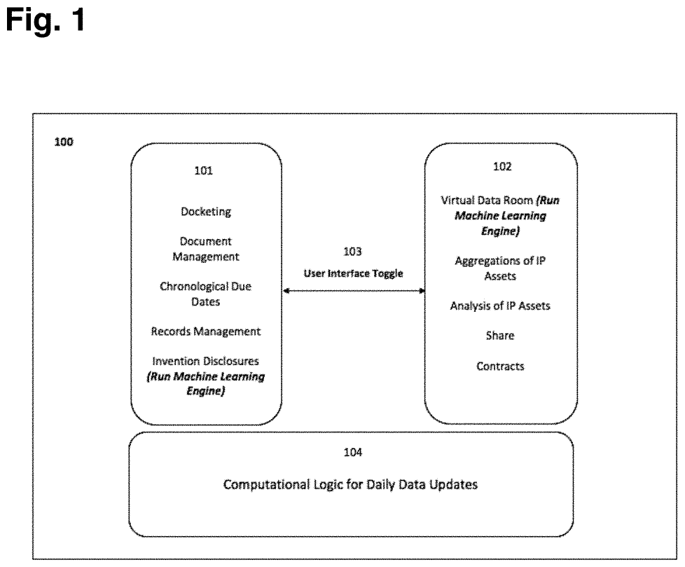

FIG. 1 shows a basic infrastructure diagram of the organization of the platform, wherein [103] represents the user interface ability to toggle between portfolio management [101] and the virtual deal room segment [102]. [104] represents the computational logic that is run continuously on all imported intellectual property assets. [104] produces new data and updates that are detected via a plurality of APIs. [101] represents the portfolio management segment of the system that includes docketing, document management, chronological due dates, records management, and invention disclosures (which includes a functionality to run the machine learning engine). [102] represents the virtual deal room segment of the system that includes a virtual data room (which includes a functionality to run the machine learning engine), an aggregated view of IP assets, share functionality, document and contract attachments and the like.

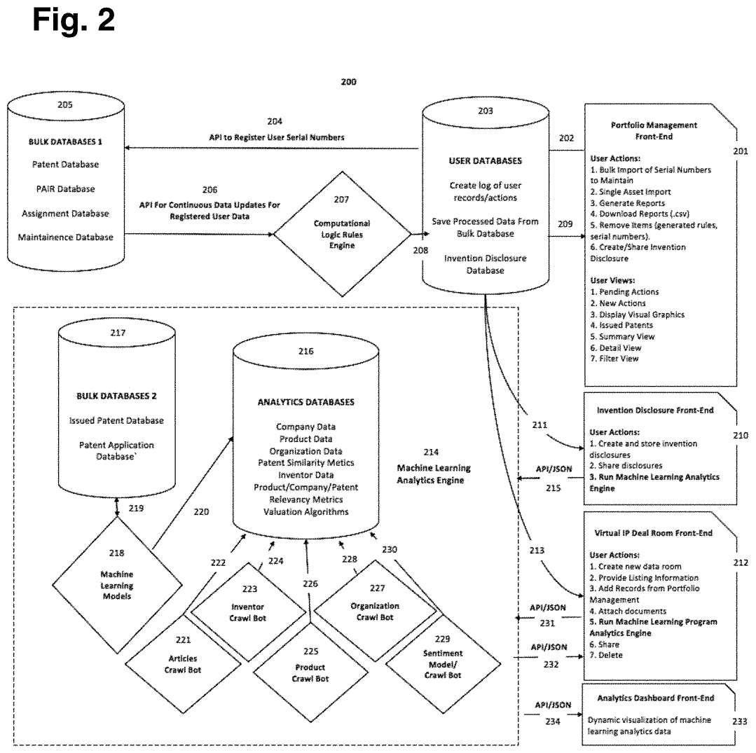

FIG. 2 is a more comprehensive representation of how the parts of the application are organized to optimize for the continuous and automated flow of information from a plurality of information sources, and the utilization of a plurality of information processing techniques to maintain integrity, robustness and speed of intellectual asset management, analysis and transaction. [201] represents the portfolio management front-end user interface where users are able to perform a number of user actions, and experience a number of user views. [201] user actions include but are not limited to, the bulk import of intellectual asset serial numbers via an Excel or .csv file, individual serial number imports, the ability to explore work flows for pending applications, a dynamic visual histogram of the receipt of new actions, a dynamic visual histogram of any outbound responses to actions, the ability to export filtered reports into .csv files, and formatted PDFs, functions to remove items such as generated rules or entire serial records, and the like. User views including toggles between pending actions, new actions, issued patents, summary views, details views, filtered views, and the like.

FIG. 2 [202]-[209] illustrates the process by which the system provides and maintains up-to-date intellectual asset management data to the Portfolio Management Front-End [201]. [202] is the process of sending the imported data from the front-end [201] to the user databases [203]. The serial numbers are logged for time of import, and provided a unique user ID at the time of import into the databases [203]. Concurrent with this process, an API submits the serials numbers for registration with a bulk databases [205] containing government intellectual asset records. Immediately upon registration, an API [206] sends updated data back to the User Databases [203]. As the new data is passed to the User Databases [203], they are processed via a computational logic rules engine [207], containing a set of rules relevant to certain data objects in the XML data incoming from the bulk databases [205]. The fully compiled serial record data [208] is then stored in the User Databases [203]. The API performs regularly scheduled updates [206], such that [206] occurs on a nightly or weekly basis.

FIG. 2. [210]-[232] illustrates the process used to augment the functions of intellectual asset analysis and transactions. [210] is the invention disclosure front-end that permits the user to the create and store invention disclosure text, share invention disclosure records, and run invention disclosures via the machine learning analytics engine [214]. The text of the invention disclosure is sent [215] to the machine learning analytics engine [214] via an API as a specified file format, such as JSON. The machine learning analytics engine [214] contains a plurality of data source inputs, and a plurality of machine learning and logical models that process the data inputs in order to produce sophisticated analytical results. All results and their related data inputs are stored in the analytics databases [216]. These may include in whole or in part, and are not limited to, organization data, product data, patent similarity metrics, inventor data, product/organization/patent relevancy metrics, valuation algorithms and the like.

FIG. 2 [218] is a machine learning process optimized for the reading, understanding and analysis of natural language pertaining to the intellectual assets contained in governmental intellectual asset corpuses. In order to provide effective document similarity search, a method to featurize documents based on the contents (words) present are provided. One important and desirable property of any document search system is true semantic and contextual similarity, rather than relying on exact word matches or simple word-to-word comparisons between documents. By way of analogy, a web search for the term “laptop” might return a result with the text “notebook pc” (and not containing the word “laptop” at all) due to the semantic similarity between the terms. In order to capture semantic similarity between words, the system utilizes embeddings (vectors) produced by the Word2Vec model, a model that is capable of capturing semantical similarities/differences for words based on context windows. A Word2Vec model is trained (in an unsupervised manner) on the intellectual asset corpuses from bulk databases [217]. For the deep learning models utilizing class labels (paragraph vectors and the convolutional network classifier, for instance) certain classification labels can be used. Existing government provided class labels are used only to aid in building the document vectors from the component word vectors; alternative class labels can be utilized with only minor changes to the data pipeline. For production use cases, it is preferable to instead utilize a synthetic language model to produce class labels. For example, the latent semantic indexing (LSI) or Latent Dirichlet Analysis (LDA) algorithms (or any other topic-modelling algorithm) could be utilized to generate any number of classes in an unsupervised manner (instead of relying on pre-defined categories such as IPC). Note that in principle, multiple class labels (for example, IPC and LSI simultaneously) could be utilized to learn document vectors in a single model via a multi-task learning architecture.

A defined evaluation approach is provided for improving the performance of the machine learning outputs for content similarity. For example, a test set comprised of (patent,patent,similarity) tuples could be utilized to rank candidate systems and validate their performance.

Overall, the intuition for the document vector similarity approach of the machine learning model [218] is as follows: each patent is mapped to a fixed length vector, based on its constituent words (or specifically, the word vectors—which capture semantic similarity between words. These document vectors can be compared using a similarity metric—such as cosine similarity—that maps pairs of document vectors to a single real-valued number. For example, similarity(X,X)=1 for any patent X; similarity(X,Y) will be close to 1 for any pair of patents X and Y with similar contents, and around 0 (or negative) for unrelated patents X and Z. Consequently, the document vectors and similarity metric are used to rank the similarity of one document with respect to all others and return those with the greatest semantic similarity. The Word2Vec model may utilized for a plurality of document similarity search models, but the means of utilizing the word vectors can differ between the models. Each document is represented as a mean vector, built from vectors of each word in document. Given a document containing words W1, . . . , WN, the document vector V is given by:

$$V = \frac{1}{N} {\sum }_{i = 1}^{N} vector ( {W}_{i} )$$

This model alone is unable to address internal noise (irrelevant words) directly. There are known solutions (more sophisticated architectures) that allow the system to reduce noise.

To improve the results of the model, the system may use, for example, the following parameters:
CBOW
10 negative samples
Window size of 5 words
Same tokenization & tokens preprocessing as for other models

Paragraph vectors (also known as Doc2Vec) is natural extension of the Word2Vec algorithm, suited to producing a vector for sequences of text (such as sentences, paragraphs or whole documents). One of key differences between paragraph vectors & Word2Vec is that paragraph vectors has ability to train classifier using labels attached to documents.

For the paragraph vectors model, the system may use the following hyperparameters:
PV-DM
Hierarchical softmax
Window size of 5 words
Same tokenization & tokens preprocessing as for other models
IPCR labels used for model training

The convolutional neural network based approach is one of most recent architectures for utilizing word vectors for natural language processing tasks such as document and sentiment classification. In this approach, the system represents each document as 2D matrix of word vectors. Each row in the input data in the word vector for the corresponding word in the document. For similarity search (vectorization of documents) we will be utilizing an additional architecture, in conjunction with the CNN: the center loss output layer. The approach is the train the model with a vector for each document based on the word vectors of the words it contains. The center loss model allows the system to learn document vectors by utilizing document label information and framing the learning problem as a (modified) classification problem. In addition to the standard property of semantically similar documents having similar vectors, document label information is used to learn document vectors with two additional desirable properties: For this model we use following parameters: 1. Inter-class dispersion (i.e., documents with different labels should have different vectors), and 2. Intra-class similarity (i.e., documents with the same label should have similar vectors)

For this model we use following parameters:
4 parallel layers with different region (context) sizes: 2, 3, 4, 5 words
W2V vectors used to feed model were not normalized
Average over time pooling is used
Models were built with and without denoising

There are number of possible improvements and training variations on the above model.

FIG. 2 [220] is the process by which the machine learning model [218] provides answers and search results based on inputs requested by the user via the user front-ends [210] and [212], and the results are stored in the analytics database [216];

FIG. 2 [221]-[230] is a separate machine learning process that captures additional information via a plurality of crawl bots and APIs instructed to collect and organize relevant information found on the Internet. [221] is an articles crawl bot that crawls and extracts written content from a wide plurality of online sources. [222] is the process by which the articles crawl bot [221] provides content related to user inputs from [210] and [212] to the analytics databases. [223] is an inventor crawl bot that crawls inventor information from a plurality of online sources and [224] is the process by which the inventor crawl bot [223] provides content related to user inputs from [210] and [212] to the analytics databases. [225] is a product crawl both that crawls product information from a plurality of online sources and [226] is the process by which the product crawl bot [225] provides content related to user inputs from [210] and [212] to the analytics databases. [227] is an organization crawl both that crawls organization information from a plurality of online sources and [228] is the process by which the organization crawl bot [227] provides content related to user inputs from [210] and [212] to the analytics databases. [229] is a sentiment model and crawl bot that crawls opinion information from a plurality of online sources and [230] is the process by which the sentiment model and crawl bot [229] provides sentiment analysis related to user inputs from [210] and [212]. All crawl bot and API processes operate by way of leveraging real-time systems to access a pre-determined range or URLs existing on the Internet. Such that, the system has defined which URL parameters to search when conducting product searches, versus organization searches.

FIG. 2 [231] is the API JSON content that is provided by the user via the virtual IP Deal Room Front-End [212], to the Machine Learning Analytics Engine [214] for processing. For example, the user has created a virtual deal room dedicated to new and improved 3D Television technology. The virtual deal room includes a plurality of intellectual assets, such as pending patent application records and their affiliated bibliographic information, issued patents and their affiliated bibliographic information, invention disclosure contents, provisional patents, and the like. The system collects all natural language relating to those assets. The aggregated natural language from the documents are used as the basis for the machine learning analytics engine [214]. The natural language is processed for input into either the machine learning model [218], and separately used to set parameters for searches within the plurality of crawl bots [221]-[229].

FIG. 2 [232] is the API JSON content that is provided to front-end [212] after the machine learning analytics engine [214] has completed processing. The processed data from the above process is then saved to the analytics database [216], and provided to a front-end. The user may select from portions of all returned data to populate the virtual deal room front-end [212], or to populate an alternative front-end.

FIG. 2 [233] is the user front-end analytics dashboard where user can dynamically explore a plurality of data provided by the machine learning engine [214], and stored in the analytics database [216]. [234] is the API JSON content that is provided to the analytics dashboard front-end [233] after processing by the machine learning analytics engine [214].

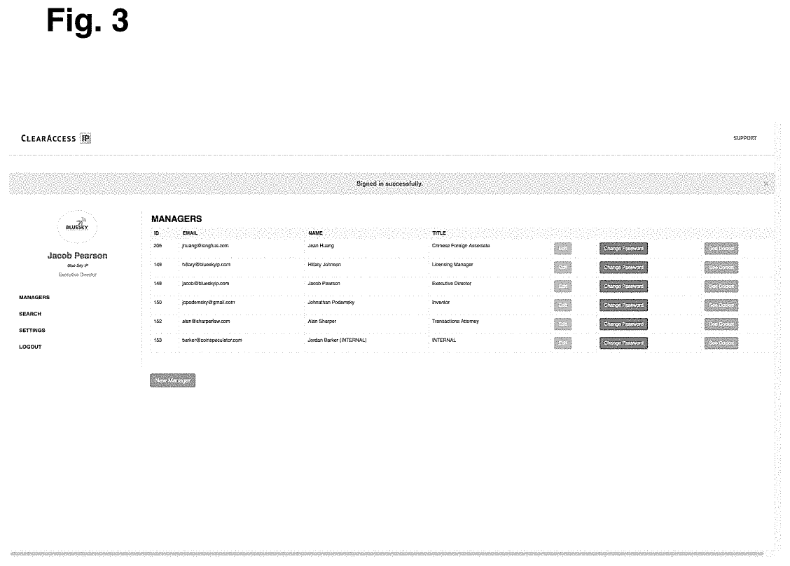

FIG. 3 is the user interface for the administrator dashboard for an enterprise account. The administrator is able to create a plurality of manager accounts, each with a unique login associated with the enterprise account. Such that, each enterprise account has a unique URL, and the manager accounts are able to access their profiles via logins available on each unique enterprise URL. Administrations are able to access each manager account via the administrator dashboard as if the user. Administrators are able to search among all manager account contents, such that any serial number is searchable via the front-end.

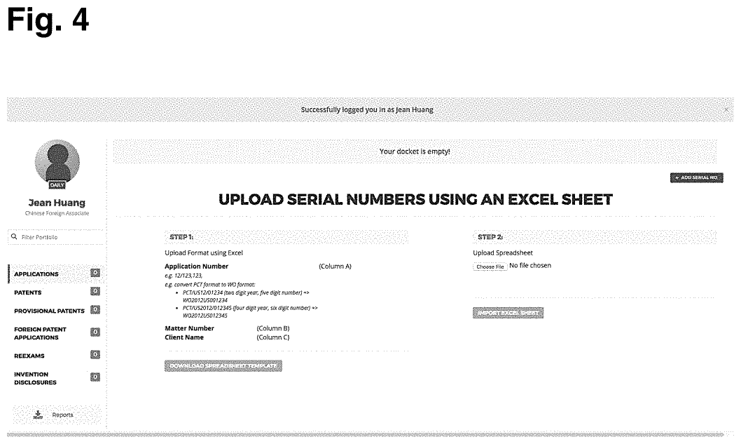

FIG. 4 is the user interface for a newly created profile, allowing the user to import new intellectual asset serial numbers. The system provides a template for the import file, such that a user can download the template directly. The template shows the user how serial numbers and related file tracking information need to be formatted on the .csv or .excel file in order for the system to successfully import and process the data.

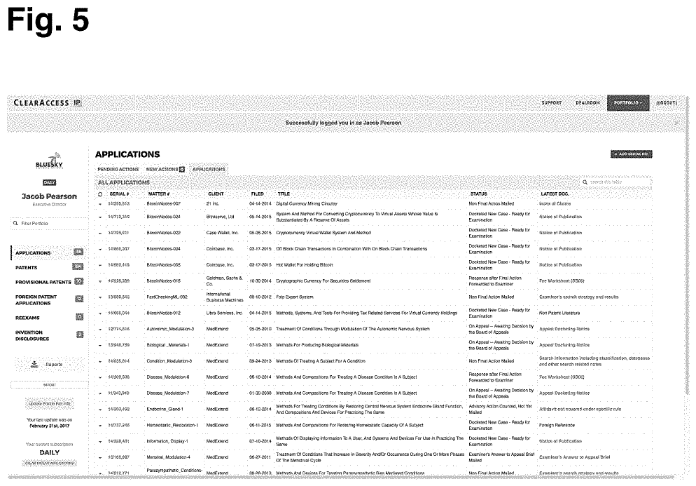

FIG. 5 is the user interface of a populated profile account, and the All Applications tab. The user has successfully completed the import process and is able to login to check for daily updates to the data. The Applications section of the platform allows users to browse pending intellectual asset data that they are tracking. The user can sort the data and review the latest information related to the transaction history, and recent actions taken by the government patent office. Live links are present that allow the user to perform a plurality of actions, including viewing the detail of each file record, and view the latest documents associated with the record. All data is maintained on a regularly scheduled basis by the process outlined in FIG. 2 [202-[209].

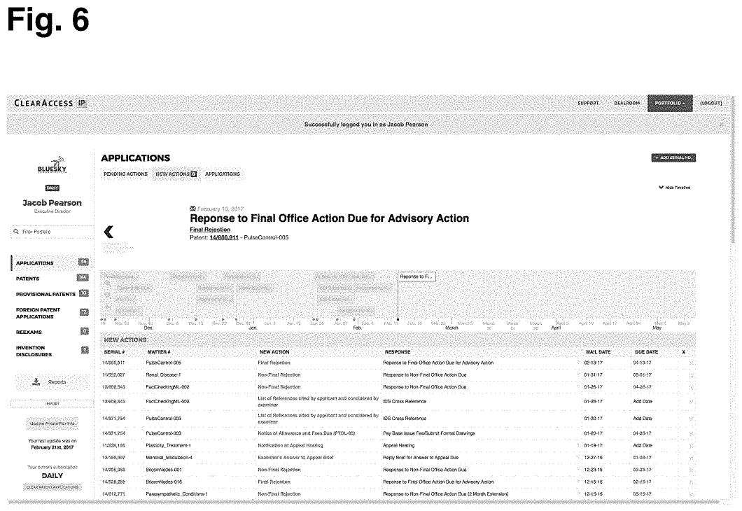

FIG. 6 is the user interface of the New Actions tab of the Applications section of the application. The UI includes a histogram of New Actions. New Actions represent any correspondence from the government intellectual property office requiring a statutory response within a defined period of time. These include, responses to non-final office actions, notice to filing missing parts, and the like. The system chronologically organizes all new actions such that the most recent actions are automatically sorted to the top of the screen. Users are able to view all pending new actions, and the statutory responses due. As users submit responses to the patent office, the system autonomously “checks-off” that the response has been submitted via the process shown in FIG. 2 [202-[209].

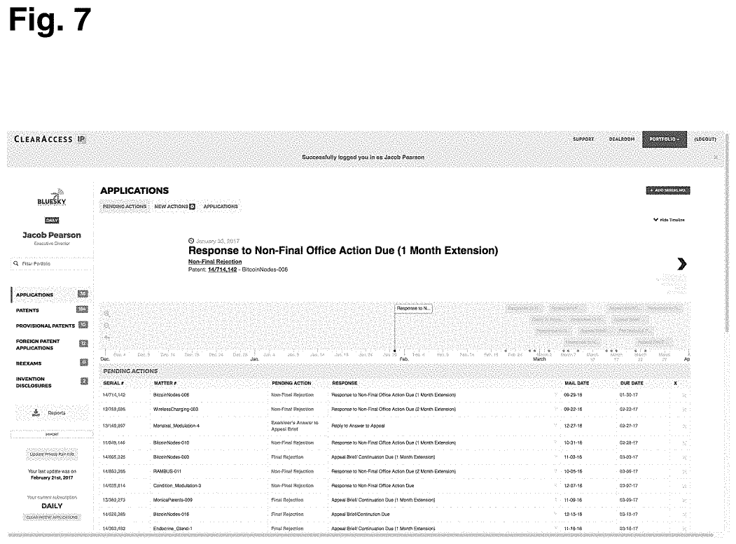

FIG. 7 is the user interface of the Pending Actions tab of the of the Applications section of the application. Pending Actions representing all upcoming due dates shown in order of the closest upcoming due date, with later due dates following in chronological order. A histogram provides an illustration of the upcoming due dates along a timeline. Users are able to perform a number of user actions, including but not limited to: select into a detail view of any serial number displayed, calendaring upcoming due dates, selecting from a drop-down menu of statutory due dates to change the due date, delete actions, view an image of the original government correspondence, and the like.

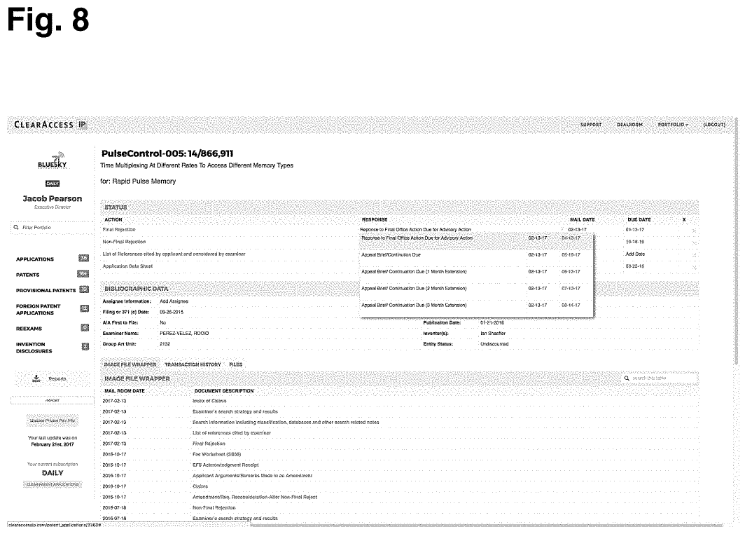

FIG. 8 is the user interface for selecting and automating any extensions related to a New or Pending Action illustrating a drop-down menu showing all bundled statutory actions. Bundled statutory actions are those in which a user can select from any number of statutory actions, such that the user can submit a response with an extension, or choose an alternative submission strategy such as, for example, filing an Appeal Brief in response to a Final Office Action.

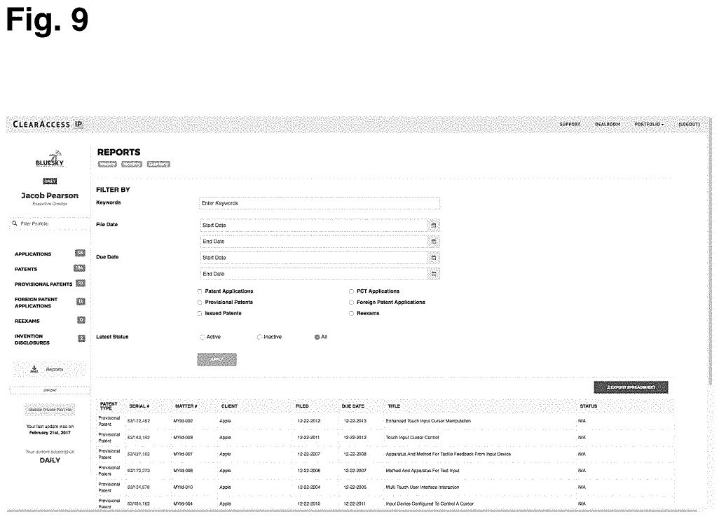

FIG. 9 is the reports generation user interface. A user is able to select from a plurality of reporting options, including but not limited to, pre-determined filter ranges such as “weekly,” “monthly,” or “quarterly” reports, and more detailed selected filters such as legal status, geographic area, keywords, client names, and the like. Reports are generated in PDF and .csv or .excel formats.

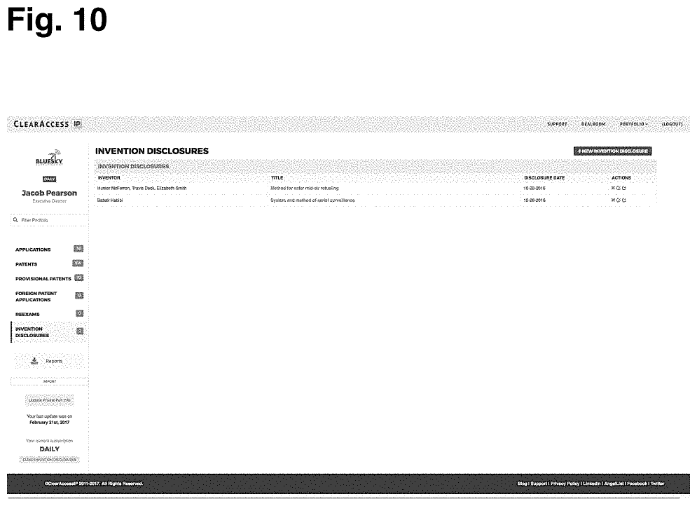

FIG. 10 is the invention disclosure user interface. The user is able to generate new invention disclosures, or select the detail view of a previously created invention disclosure. Users are able to share, delete and edit invention disclosures. Users are able to also submit the invention disclosure to the machine learning engine for processing via the process outlined in FIG. 2. [215]-[229] to return relevant data outputs for viewing in, for example, an analytics dashboard front-end such as the one shown in FIG. 2 [232].

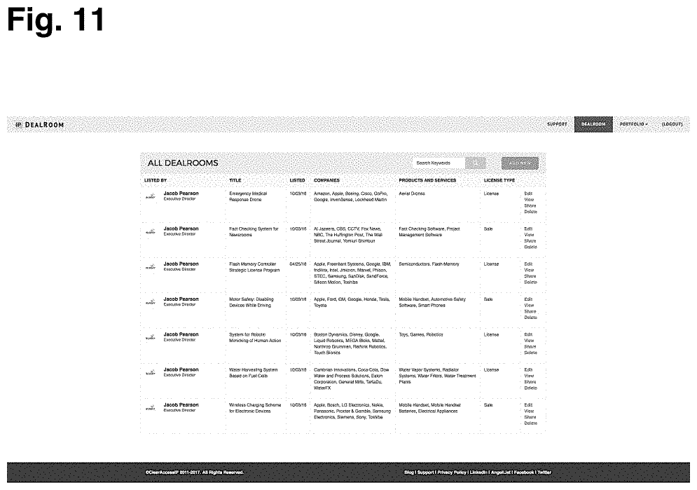

FIG. 11 is the All DealRooms interface of the virtual deal room. The All DealRooms interface allows users to see a summary view of all virtual deal rooms. The summery all deal rooms view allows the user to edit an existing virtual deal room, view it, share it via an encrypted URL, or delete the entry. A user may also search through deal rooms, and add a new one.

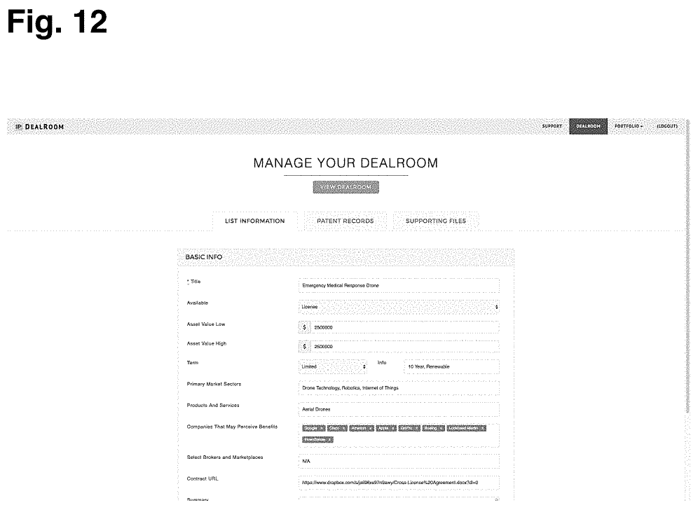

FIG. 12 is the creation and edit view of a selected virtual deal room. In this embodiment, the default interface tab allows the user to enter list information about the intellectual asset portfolio. The list information includes, but is not limited to, a title of the portfolio, the type of transaction the portfolio is available for, an estimated asset value range, a summary of any term limitations, primary market sectors, products and services that relate, companies that may perceive benefits, brokers and marketplaces, links to contracts, and a summary of the portfolio. Fields can be hand entered, or in an alternative embodiment, the user may choose to select and input fields that are generated by the Machine Learning Engine (FIG. 2. [215]-[229]). Users are able to define the available transaction type and select from a menu with virtual deal room categories such as license, sale, cross-license, pledge, pool, internal review, and the like.

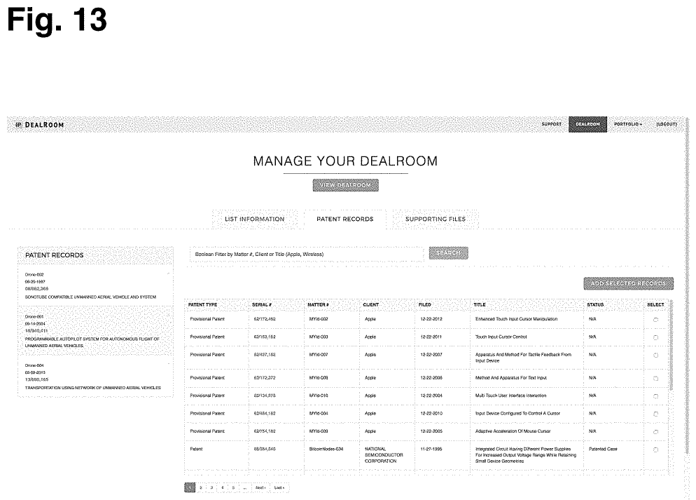

FIG. 13 is the edit view of a selected virtual deal room, with the Patent Records selection interface tab in view. In this tab, the user is able to explore and add intellectual property assets to the virtual deal room. The system provides direct access to the data managed via the Portfolio Management Front End (FIG. 2 [201]), and supported via the process in FIG. 2 [202]-[208]. Users are able to search and select from the data contained in the User Databases (FIG. 2) [203]. Once users select the relevant assets from the interface, the assets are stored in association with the specified virtual data room. Each virtual deal room is a column within a database and is provided with a unique virtual deal room identifier. The selected intellectual property assets are then associated with the unique virtual deal room identifier.

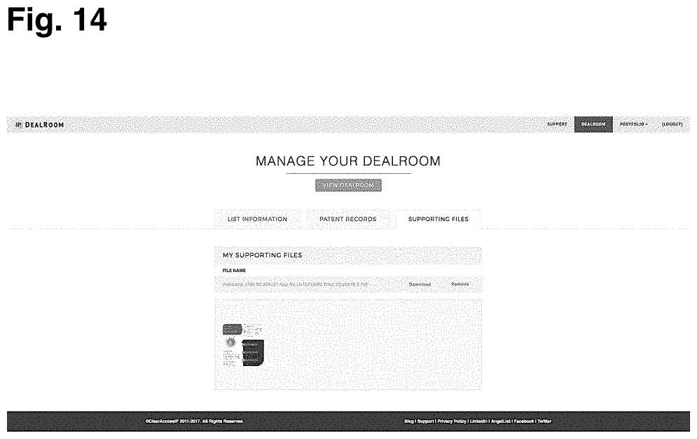

FIG. 14 is the edit view of a selected virtual deal room, with the Supporting Files selection tab in view. Users can drag and drop files from their desktop or other location into the virtual data room.

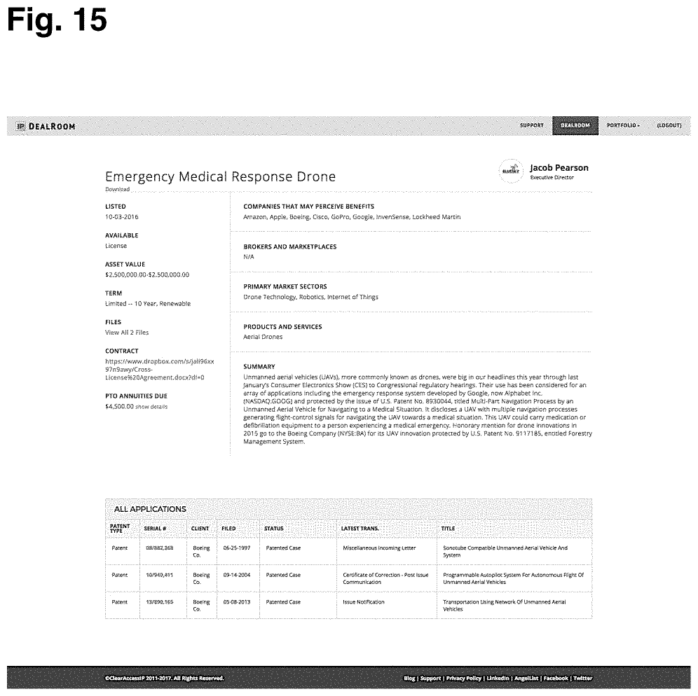

FIG. 15 is the user interface of a completed virtual deal room. A completed user virtual deal allows a user to select a view-only option for easy and cohesive review of the deal room. The deal room comes with structured HTML that organizes the entered data and links in a cohesive manner that is intuitive for the viewer.

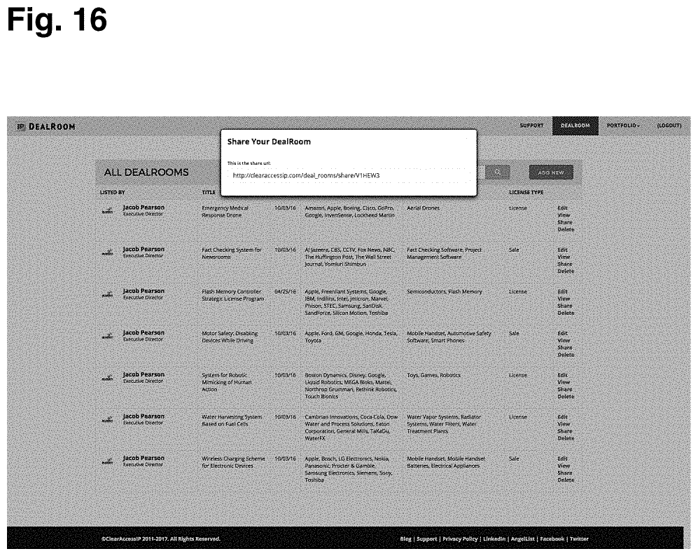

FIG. 16 is the user share option for individual deal rooms. The share options populates a unique and encrypted URL. The URL is sharable thereby making the view-only version of the virtual deal room accessible to anyone with the link.

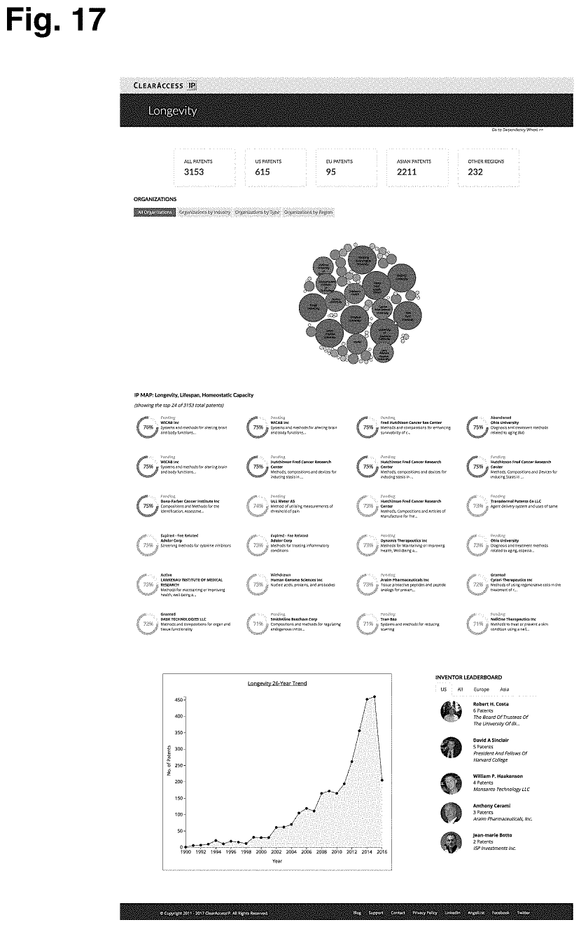

FIG. 17 is the user interface of the analytics dashboard using the data produced by the Machine Learning Analytics Engine FIG. 2. [215]-[229]. The dashboard includes dynamic visualizations that allow the user to select from a variety of data display options. In one embodiment the user can select from data produced from the Machine Learning Engine (FIG. 2. [215]-[229]), and produce visualizations that allow them to explore relevant organizations by organization type, industry and region. The user is also able to explore a plurality of relevant patents, timelines, relevant products, inventors, publications, and other relevant material collected and processed by the Machine Learning Engine (FIG. 2. [215]-[229]). Finally, the user can dynamically select and pair data for relevancy analysis, such that a user can compare relevant patents to relevant products, and include other combinations of analysis to companies, inventors, and the like. In the preferred embodiment, data from the Machine Learning Engine (FIG. 2. [215]-[229]) is provided to the application and displayed on the front-end of the application dashboard using a plurality of JavaScript libraries. The user makes a request to view the data via the front-end Ruby on Rails (or similar) application. The application then sends the user request via JSON to the Machine Learning Engine (FIG. 2. [215]-[229]) which is written in Phython (or similar). The Phython results (responses) are then sent back to the Ruby on Rails application in JSON format, and parsed and organized for presentation via the front-end JavaScript.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A platform for the semi-autonomous management, analysis and distribution of intellectual property assets, said platform comprising:
a portfolio management front-end interface;
an automated monitoring application for correlating docketing information with IP assets;
an invention disclosure front-end;
a virtual data room application for presenting the correlated docketing information with the uploaded IP assets to the users;
a machine learning engine that processes a plurality of functions and data; and
an analytics dashboard front-end for user exploration of the machine learning analytics engine's results.
